(19) United States
(12) Patent Application Publication
(10) Pub. No.: US 2024/0007408 A1
(43) Pub. Date: Jan. 4, 2024

(54) SENSOR APPARATUS AND METHOD FOR DETECTING INTERACTING AND RELATED NETWORK FLOWS

(71) Applicant: Raytheon BBN Technologies Corp., Cambridge, MA (US)

(72) Inventors: Prithwish Basu, Westford, MA (US); Christophe Jean-Claude Merlin, Wakefield, MA (US); Owen Hope, Somerville, MA (US)

(21) Appl. No.: 18/169,634

(22) Filed: Feb. 15, 2023

Related U.S. Application Data
(60) Provisional application No. 63/331,420, filed on Apr. 15, 2022.

(51) Int. Cl. H04L 47/2441; H04L 47/2491; H04L 47/2483

(52) U.S. Cl. CPC H04L 47/2441; H04L 47/2491; H04L 47/2483

(57) ABSTRACT

According to at least one aspect of the present disclosure, a method for determining whether two flows are related is provided. The method comprises identify a first flow; identify a second flow; collect one or more attributes of one or more packets of the first flow and second flow during an interval of time; determine a flow similarity of the first flow and the second flow based on the one or more attributes; determine that the flow similarity exceeds a similarity threshold; and responsive to determining that the flow similarity exceeds a similarity threshold, determine that the first flow and second flow are related flows.

### CROSS-REFERENCE TO RELATED APPLICATIONS

This application claims priority under 35 U.S.C. § 119(e) to U.S. Provisional Application Ser. No. 63/331,420 titled DISTRIBUTED TENSOR APPARATUS AND METHOD USING TENSOR DECOMPOSITION FOR APPLICATION AND ENTITY PROFILE IDENTIFICATION filed on Apr. 15, 2022, which is hereby incorporated by reference in its entirety for all purposes.

### STATEMENT REGARDING FEDERALLY-SPONSORED RESEARCH OR DEVELOPMENT

This application was made with government support under Contract No. W911NF-19-C-0042 awarded by the U.S. Army. The United States Government may have certain rights in this invention.

### BACKGROUND

The internet is composed of numerous network nodes, such as routers, switches, servers, user devices, and so forth. When nodes communicate, they open network connections between each other to transmit data.

### SUMMARY

According to at least one aspect of the present disclosure, a method for determining whether two flows are related is provided. The method comprises identify a first flow; identify a second flow; collect one or more attributes of one or more packets of the first flow and second flow during an interval of time; determine a flow similarity of the first flow and the second flow based on the one or more attributes; determine that the flow similarity exceeds a similarity threshold; and responsive to determining that the flow similarity exceeds a similarity threshold, determine that the first flow and second flow are related flows.

In some examples, determining the flow similarity of the first flow and the second flow includes: determining a first similarity of the first flow to the second flow; determining a second similarity of the second flow to the first flow; and determining a composite similarity based on the first similarity and the second similarity, wherein the flow similarity is based on the composite similarity. In many examples, collecting one or more attributes of one or more packets of the first flow and second flow during an interval of time includes: dividing the interval of time into a plurality of subintervals of time; and determining that each subinterval of the plurality of subintervals has a statistically significant quantity of the one or more packets associated with it.

In various examples, determining a similarity of the first flow to the second flow further comprises determining a similarity of the one or more packets of the first flow and the second flow with respect to each subinterval of time of the plurality of subintervals of time. In some examples, determining a similarity of the one or more packets of the first flow and the second flow with respect to each subinterval of time includes: determining a first similarity of packets of the first flow with respect to packets of the second flow; determining a second similarity of packets of the second flow with respect to packets of the first flow; and determining a composite similarity of the subinterval based on the first similarity and the second similarity.

In many examples, the composite similarity is an average of the first similarity and the second similarity. In various examples, the method further comprises determining the flow similarity based on each composite similarity of each subinterval. In various examples, the flow similarity is determined based on a proportion of subintervals having a composite similarity above a threshold similarity. In some examples, the number of the subintervals is greater than a number of the subintervals having a composite similarity above the threshold similarity. In many examples, determining that the flow similarity includes determining that the proportion of subintervals having a composite similarity above a threshold composite similarity is greater than the threshold proportion.

According to at least one aspect of the present disclosure, a system for determining whether two flows are related is provided. The system comprises at least one sensor configured to monitor a first flow and a second flow; and a controller configured to: determine one or more attributes of one or more packets of the first flow and the second flow during an interval of time; determine a flow similarity of the first flow and the second flow based on the one or more attributes; and responsive to determining that the flow similarity exceeds a threshold flow similarity, categorize the first flow and second flow as related flows.

In various examples, the controller is further configured to: divide the time interval into a plurality of subintervals of time. In many examples, the controller is further configured to determine whether a subinterval contains a statistically significant quantity of packets associated with the first flow and the second flow; and discard subintervals of the plurality of subintervals that do not have a statistically significant quantity of packets associated with the first flow and the second flow. In some examples, the controller is further configured to: determine a first similarity of packets associated with the first flow to packets associated with the second flow for a respective subinterval; determine a second similarity of packets associated with the second flow to packets associated with the first flow for the respective subinterval; and determine a composite similarity based on the first similarity and the second similarity.

In many examples, the composite similarity is an average of the first similarity and the second similarity. In various examples, determining the flow similarity is based upon each respective composite similarity of each subinterval. In some examples, the flow similarity is a proportion of subintervals having a composite similarity above a threshold similarity to a number of subintervals. In various examples, the number of subintervals is all subintervals except those discarded.

According to at least one aspect of the present disclosure, a non-transitory, computer-readable medium containing thereon instructions for determining the relatedness of two flows, the instructions instructing at least one processor to: identify a first flow; identify a second flow; collect one or more attributes of one or more packets of the first flow and second flow during an interval of time; determine a flow similarity of the first flow and the second flow based on the one or more attributes; determine that the flow similarity exceeds a threshold flow similarity; and responsive to determining that the flow similarity exceeds the threshold flow similarity, determine that the first flow and second flow are related flows is provided.

According to at least one aspect of the present invention, a method for determining whether two flows are related and carry the same service is provided. The method comprises collecting one or more attributes of one or more packets of the one or more flows during an interval of time; modeling one or more flow characteristics based on the one or more attributes to produce one or more modeled flow characteristics; comparing the flow characteristics to one or more modeled flow characteristics; grouping the flows based on a similarity of the flow characteristics to the modeled flow characteristics; and identifying related flows based on the grouping of flows.

In some examples, the method further comprises extracting cumulative flow size versus time over periods of time responsive to collecting the one or more attributes, and wherein cumulative flow size versus time is used to model the one or more flow characteristics to produce the one or more modeled flow characteristics. In various examples, modeling the one or more flow characteristics to produce the one or more modeled flow characteristics includes using linear regression. In many examples, modeling the one or more flow characteristics to produce the one or more modeled flow characteristics includes using nonlinear regression. In some examples, comparing the one or more flow characteristics to the one or more modeled flow characteristics includes comparing or plotting at least one flow characteristic on a multidimensional graph. In various examples, grouping the flows includes using clustering algorithms. In many examples, the clustering algorithm is the nearest neighbor clustering algorithm. In various examples, identifying related flows based on the grouping of flows including validation of the grouping and reorganization of the grouping based on a set of rules.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a network according to an example;

FIG. 2 illustrates a network segment according to an example;

FIG. 3 illustrates a network segment according to an example;

FIG. 4 illustrates a process for classifying a flow or group of flows according to an example;

FIG. 5 illustrates a tensor decomposition according to an example;

FIG. 6 illustrates a graph demonstrating tagging of clusters according to an example;

FIG. 7 illustrates a process for tagging flows according to an example;

FIG. 8 illustrates a system having a network and a controller according to an example;

FIG. 9A illustrates a process for training a machine learning algorithm to detect a multiplexed or tunneled flow according to an example;

FIG. 9B illustrates a process for determining whether a flow is multiplexed or tunneled according to an example;

FIG. 10 illustrates a process for demultiplexing a multiplexed or tunneled flow according to an example; and

FIG. 11 illustrates a process for determining whether two flows are related to one another according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Telecommunication networks are networks of devices— typically computers, routers, switches, and so forth— that facilitate the transmission of data from an origin node (often a computer) to a destination node (often a computer) in the network. Each device on the network may be a node of the network. Common examples of modern telecommunication networks include cell-phone networks, satellite communication networks, and the Internet. In general, data transmitted on telecommunication networks is structured in discrete packets having a given size (usually measured in bytes). Packets are often transmitted at a given rate (usually measured in bits per second or bits per some other unit of time). Packets can contain information, including IP and port addresses, raw data, checksum information, packet length information, protocol version information, offsets, optional options, and so forth. Packets are generally encoded, meaning that the information they contain is structured according to one or more protocols that define how a particular sequence of bits (for example, 1s and 0s often represented by voltages or ranges of voltages) should be interpreted.

When an origin node wishes to send data to a destination node, the origin node opens a network connection with the destination node. The network connection is typically structured according to one or more protocols (for example, TCP), and will typically be a 2-way connection allowing a node to both receive packets from and transmit packets to another node. In some cases, a network connection may refer to either the connection between any two directly linked nodes, or the connection between the original origin node and the ultimate destination node, regardless of the number of nodes between said origin and destination node.

Network connections may carry flows. In some examples, flows are sets of related packets. For example, a given application located on a first node may communicate with a given application on a second node. The application may generate a flow (e.g., of packets) from the first node to the second node. In some examples, the second node may also generate a flow to the first node, possibly in response to receiving some or all of the flow from the first node. In most examples, flows travel in only a single direction at a time between two nodes.

On highly active networks, such as the Internet, it can be difficult to identify which packets belong to a given flow, and therefore distinguish between flows, especially when observing flows from an outside perspective (that is, from a perspective other than that of the origin node or destination node). Aspects and elements of the present disclosure are directed to identifying the flows' originating application or application type, or classifying flows thereafter. In particular, this disclosure discusses using tensor decomposition (to drive clustering of packets), landmark (or signature) characterization, binning, and distance metrics to classify flows. Aspects, methods, and systems of this disclosure do not rely on traditional methods of classifying packets and flows, such as Deep Packet Inspection (DPI).

For the purposes of this application, the term “service” will include applications, application types, computer services, activities, and other things capable of communicating on a network, including things capable of requesting, providing, or controlling flows and/or the creation of flows. Services may include, for example, specific computer programs (applications) or classes of computer programs (e.g., all those using a given protocol to communicate on the network), and so forth.

Flow Classification

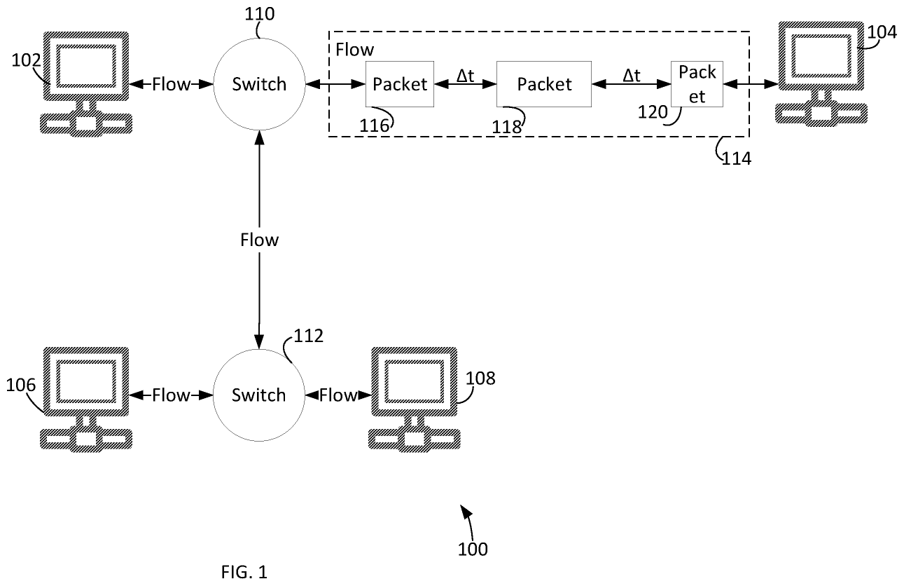

FIG. 1 illustrates a network 100 according to an example. The network 100 has a plurality of nodes including a first node 102, a second node 104, a third node 106, a fourth node 108, a fifth node 110, and a sixth node 112. The network also includes at least one flow 114 between nodes, the flow including a first packet 116, a second packet 118, and a third packet 120.

The fifth node 110 is coupled to the first node 102, the second node 104, and the sixth node 112. The sixth node is coupled to the third node 106, fourth node 108, and fifth node 110.

The first, second, third, and fourth nodes 102, 104, 106, 108 are terminal nodes of the network 100, meaning that each of them has only a single connection to another node on the network 100. The fifth and sixth nodes 110, 112 are switching nodes configured to route data on the network from one terminal node to another terminal node, possibly via another switching node. As an example, data originating from the first node 102 and bound for the fourth node 108 may be routed from the first node 102 to the fifth node 110, and from the fifth node 110 to the sixth node 112, and from the sixth node 112 to the fourth node 108. Any of the nodes of the plurality of nodes may generate data, packets, flows, and so forth. Likewise, the terminal nodes 102, 104, 106, 108 and switching nodes 110, 112 may be any type of device capable of communicating on a network.

The flow 114 is representative of flows on the network. As shown, the flow 114 is a flow between the second node 104 and the fifth node 110. The flow 114 contains a number of packets 116, 118, 120. Packets are collections of bits that contain information. The network nodes 102, 104, 106, 107, 110, 112 route packets from node-to-node so that information can be transmitted via the network 100 and its internal connections, such as the flows.

Each packet has a packet size, also called a packet length, typically in bytes. In FIG. 1, the first packet 116 is larger than the third packet 120 and smaller than the second packet 118. This means the first packet 116 contains more bytes than the third packet 120 and fewer bytes than the second packet 118. In general, packets may be of any length. As a result, the packets of the flow 114 can be the same length (that is, contain the same number of bytes) or can be of different lengths. An amount of time, represented as Δt (called the “interpacket interval” or “interpacket time”), passes between each packet. That is, the first packet 116 may arrive at a node (e.g., the fifth node 110) at a first time Then, an interval of time may pass before the second packet 118 arrives. After the second packet 118 is received, another interval of time may pass before the third packet 120 is received, and so forth. The interpacket interval between packets of a flow may be constant or variable. In practice, the interpacket interval will generally be at least somewhat variable. As shown, the interval of time between the first packet 116 and second packet 118 is shorter than the interval of time between the second packet 118 and the third packet 120.

Additionally, a packet may take time to arrive. That is, from the moment an origin node transmits a packet to the moment the destination node fully receives the packet may be a non-zero period of time. This period of time is called the packet duration.

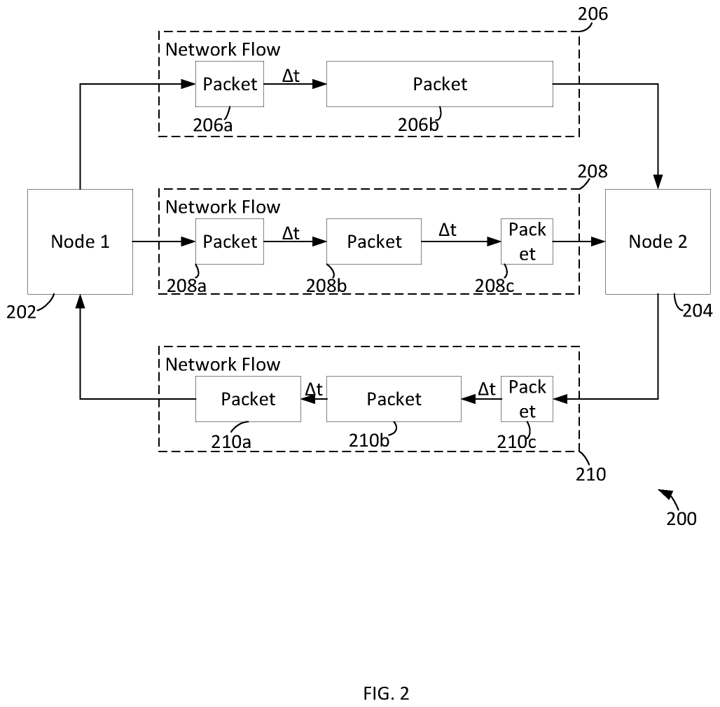

FIG. 2 illustrates a network segment 200 having a plurality of flows between two nodes according to an example. The network segment 200 includes a first node 202, a second node 204, a first flow 206, a second flow 208, and a third flow 210. The first flow 206 contains a first packet 206a and a second packet 206b, the second flow 208 contains a third packet 208a, a fourth packet 208b, and a fifth packet 208c, and the third flow contains a sixth packet 210a, a seventh packet 210b, and an eighth packet 210c.

As shown multiple flows may exist between two (or more) nodes of a network at any given time. The flows may be traveling in the same or different directions. For example, the first and second flows 206, 208 are traveling from the first node 202 to the second node 204, while the third flow 210 is traveling from the second node 204 to the first node 202. Each flow 206, 208, 210 contains one or more packets: in some examples, a single packet may be sufficient to transmit all the data desired to be transmitted, while in other examples more than one packet may be required to transmit all the data desired to be transmitted. Each flow 206, 208, 210 has its own characteristics and requirements. For example, the packets of the third flow 210 may be longer than the packets of the second flow 208 and may have comparatively shorter interpacket intervals between each packet (either in absolute terms or on average and/or in general), while the packets of the first flow 206 may have greater packet length on average than the packets of the second flow 208 but have comparatively equal or longer interpacket intervals.

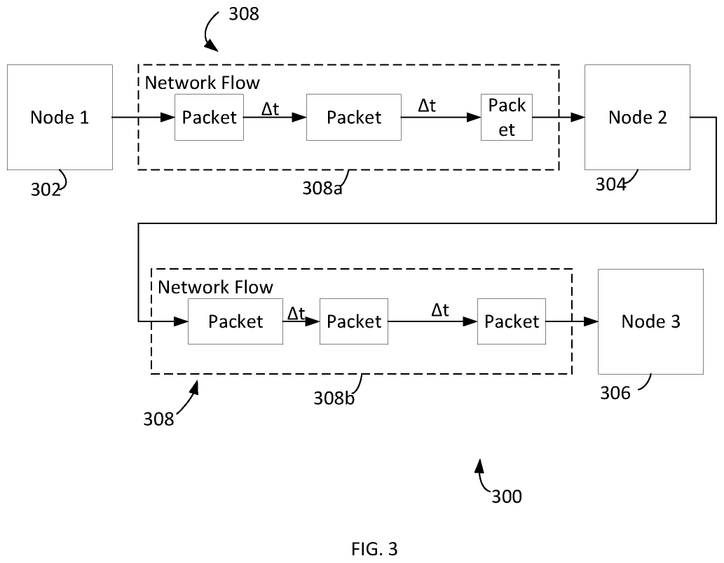

FIG. 3 illustrates a reencoding of packets between nodes in a network segment 300 according to an example. The network segment 300 includes a first node 302, a second node 304, and a third node 306. The network segment also includes a flow 308. The flow 308 is represented by a first version of the flow 308a corresponding to a first point in time when the flow 308 is between the first node 302 and the second node 304. The flow 308 is further represented by a second version of the flow 308b corresponding to a second point in time when the flow 308 is between the second node 304 and the third node 306. In terms of raw data, both versions of the flow 308a, 308b may contain the same substantive data, however, the packets of the flow 308 may be reencoded between one step (that is, transmission from the first node 302 to the second node 304) and the next step (that is, transmission from the second node 304 to the third node 306). As a result, the attributes (packet length, interpacket interval, packet duration, and so forth) of the flow 308 may vary from one point in time to another point in time.

As shown, the packets of flow 308 at the first point in time corresponding to the first version of the flow 308a are of different length and have different interpacket intervals compared to the packets of the flow 308 at the second point in time corresponding to the second version of the flow 308b. However, the substantive data of the two versions of the flow 308, 308a, 308b may be identical.

The reason for the difference in packet length and interpacket intervals may be due to any number of factors. For example, the second node 304 may have reencoded the packets according to a different standard using a different compression algorithm, or the second node 304 may have adjusted the packet header data during the forwarding and/or routing process. These are not the only reasons for variations in packet length and time intervals, and other causes may also be responsible for the variations in a flow during different steps, such as the hop from the first node 302 to the second node 304 and the hop from the second node 304 to the third node 308, in the journey from origin to destination node.

From FIGS. 1, 2, and 3 it may be concluded that multiple flows may exist on a network (e.g., network 100) at any time, that the packets of the flows may coincide in time, and that the packets of the flows may change from one step (i.e., traveling from a first node to a second node) to another step (i.e., traveling from a second node to a third node). However, as will be described in greater detail below, despite these difficulties, it is still possible to identify, classify, and characterize individual and/or related flows and/or groups of flows using the methods and systems described herein.

Flows or groups of flows may be classified using a statistical approach incorporating tensor decomposition, binning, clustering of packets, landmark (or signature) characterization, and distance and/or similarity metrics. Unlike existing methods and systems, the present clustering methods and systems do not necessarily rely on or use Euclidean distance metrics and do not lose meaning as the dimensionality of the tensors increases towards large values and/or infinity. However, in some examples, Euclidean distance metrics may also be used for clustering. Additionally, aspects of the current methods and systems may use machine learning models, algorithms, and systems to determine similarity.

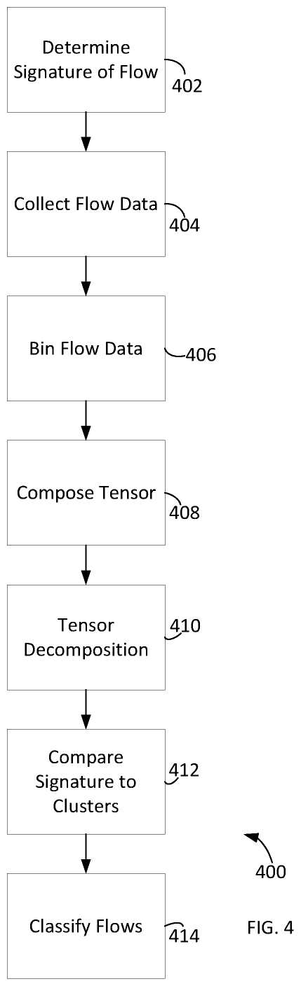

FIG. 4 illustrates a process 400 for classifying a flow or group of flows according to an example.

At act 402, one or more signatures of flows from a service (such as an application or application-type) are determined. A signature may be determined by a controller, such as a computer, server, cloud computing system, or other computational device. A signature of the service's flow and/or flows is a metric or set of metrics that represents the archetypical attributes of the flows. For example, a signature may include one or more values corresponding to packet length, interpacket interval, and/or any other set of attributes desired (such as statistical moments, variances, minima, maxima, and so forth, of the values associated with the packets).

In some examples, the flow classification is determined using a machine learning algorithm. The machine learning algorithm may be trained on data corresponding to flows of a given type. For example, the machine learning algorithm may be trained on a flow or one or more associated flows originating from a given service, such as voice-over-internet protocols, video streaming protocols, messaging protocols, downloading and/or uploading protocols, other computer services, and so forth. Data about a given flow or group of flows may be acquired by creating a controlled network environment and operating a service to communicate on that network environment while using sensors to monitor the packets and/or flows created by the service. In some examples, the signatures may be stored for later use.

At act 404, the controller receives data pertaining to packets of a flow. The data may be acquired via sensors configured to monitor packet length, interpacket intervals, or other attributes associated with flows and/or packets. In some examples, the sensors may be associated with one or more nodes of the network, and may monitor network activity directly by acquiring data concerning network activity from the nodes (for example, acquiring data directly from routers, network switches, or other network devices). In some examples, the sensors may be placed anywhere suitable to gather flow data.

The flow data collected may be categorical or numerical, and may be acquired directly by the sensors or derived (e.g., by the controller) from acquired data. For example, numerical data may be data that can be expressed in a purely numeric form, such as interpacket intervals, packet lengths, various statistical moments and/or variances, entropy of the bits and/or bytes of the packets, and so forth. Additionally, flow data, including numerical data, may come in any form, including non-integer form. For example, an interpacket interval or an average interpacket interval between packets of a flow may be a fractional value, such as a float, long, or other type of non-integer value. Flow data may also come in the form of other values, such as strings or characters. Categorical data may be flow data that cannot be expressed numerically, or which may be inconvenient to express numerically, or which may not be suitable for use with mathematical operators. Categorical data may include data such as domain of origin or the most recent network node at which a packet was observed, or the protocol the packet has been transmitted and/or encoded with, as well as abstract values that can be expressed numerically but which lose meaning when expressed numerically.

Flow data may be collected over an interval. For example, the interval may be 20 seconds, and may include subintervals of uniform or variable length (for example, 20 1-second intervals or 1 10-second interval and 10 1-second intervals, and so forth). In some examples, the flow data collection interval is 20 seconds. In some examples, the flow data collection interval is not 20 seconds, and may be greater or lesser than 20 seconds. The process 400 may then continue to act 406.

At act 406 the controller bins the flow data. Binning the flow data means associating the data with an integer. Binning can take either and/or both categorical and numerical data and associate those data to one or more integers. Ranges of the flow data may also be binned (i.e., associated with an integer). For example, packet sizes may range between 60 and 1200 bytes. To bin the packet size data, the controller may associate packets of 60-70 bytes with 0, from 70-90 bytes with 1, 90-95 bytes with 2, 95-120 bytes with 3, and so forth. Binned data may be uniformly distributed (that is, every n values within a range are binned with a given integer, where n is an integer) or variably distributed (that is, variable ranges of values within a range are associated with a given integer; in some examples, variable distributed data may be distributed logarithmically or linearly). Any type of data collected from the flows, and any attributes derived based on that data (e.g., variances, statistical moments, and so forth) may also be binned.

The method of binning data to a given integer value may be determined empirically based on experimentation to determine what gives the best results, by a machine learning algorithm, or by the user based on the user's preferences. The bins (and signatures) may also be updated during operation. For example, the controller may observe the minimum and maximum values of an attribute of a flow, such as the minimum packet length and the maximum packet length. Using the machine learning model or algorithm, the controller can adjust the ranges of the binned data to account for the shifting minimums and maximums. This, in effect, operates as an adjustment of the signature of the flow over time. In some examples, the controller may also incorporate historical binning ranges and/or signatures into the determination of the new binning ranges and/or signatures. In some examples, the controller may store old signatures for future use.

Once the flow data is binned, the process 400 may continue to act 408.

At act 408, the controller composes the binned data into a tensor. The tensor may have n-dimensions, where n is an arbitrary integer value greater than or equal to 1. The number of dimensions of the tensor may be determined by the number of distinct types of attribute collected based on the flow data. For example, if only packet length is collected, the tensor may be 1-dimensional. However, if packet length, variance of packet length, and a statistical moment of packet length are collected, the tensor may be 3-dimensional. The process 400 may then continue to act 410.

At act 410, the controller decomposes the tensor into one or more rank 1 tensors (“elementary tensors”) and clusters the flow data based on the elementary tensors. In some examples, the elementary tensors are the clusters, meaning each flow associated with a given elementary tensor is part of a given cluster. The controller can then take each elementary tensor and associate one or more flow to that elementary tensor. In some examples, the controller may bin a given flow to a given point in the tensor. For example, in a tensor having two dimensions, a flow may be binned to a point of (0,4) in the space. A second flow may be binned to (1, 3). The cluster may be all flows corresponding to points within a range of spaces. For example, the cluster may be all flows in a space defined by all points between (0,0) and (4,4) in the space. Once the flows are associated with a given elementary tensor (i.e., once the flows are clustered based on the tensor), the process 400 may continue to act 412.

At act 412, the controller compares the various clusters (i.e., the flows associated with a given elementary tensor) to the known flow signatures of act 402. In some examples, the controller may measure the similarity of the cluster to the signatures using a Euclidean distance metric and/or a non-Euclidean distance metric. In some examples, the controller may use a machine learning algorithm to compare the clusters to the signatures. The controller may associate the clusters with a signature according to the one or more metrics described herein. As a result, the flows associated with the cluster will be associated with the best fitting signature. The process 400 may then continue to act 414

At act 414, the controller classifies flows as belonging to one or more services associated with the best fitting signature. As an example, a best fitting signature for a given elementary tensor and/or cluster might be a voice-over-internet protocol (VoIP) signature for a VoIP service. The controller could then classify every flow in the cluster (that is, every flow in the elementary tensor) as belonging to the VoIP flow of the VoIP service type.

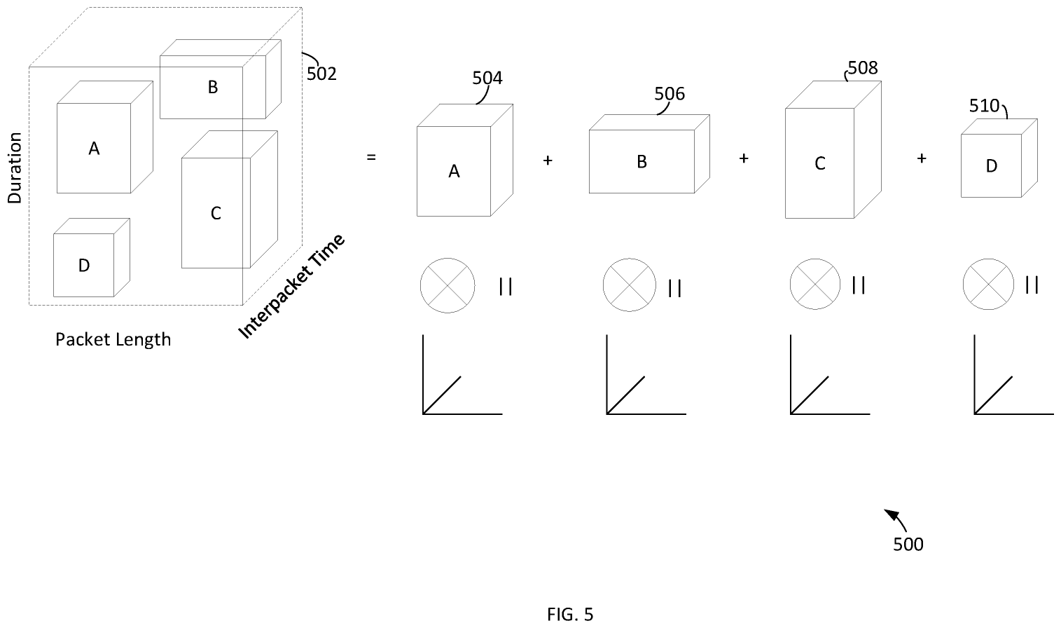

FIG. 5 illustrates a tensor decomposition 500 according to an example. The tensor decomposition 500 includes a composite tensor 502 having— in this example— three dimensions. The dimensions correspond to packet length, interpacket time mean (the mean time between packets), and flow duration. The tensor decomposition 500 also includes four elementary tensors, including tensor A 504, tensor B 506, tensor C 508, and tensor D 510.

The four elementary tensors 504, 506, 508, 510 are the decomposition of the composite tensor 502. The composite tensor 502 may be formed via recording the data associated with packets sensed at a node or on a flow between two nodes. Each elementary tensor 504, 506, 508, 510 may represent a cluster of flows that will collectively be associated with a given signature and thus classified as belonging to a given service and/or services.

In various examples, the decomposition of the composite tensor 502 into the elementary tensors 504, 506, 508, 510 may be based upon the minimum description length, according to information theory, needed to achieve compression to minimize the total number of bits and/or bytes used to encode the flow data or model.

The elementary tensors 504, 506, 508, 510 may represent clusters of flows. That is, a given cluster may exactly correspond to the constituent flows of a given elementary tensor 504, 506, 508, 510. Thus, in some examples, clusters and elementary tensors may be synonymous and/or identical. In some examples, flows may be associated with two or more composite tensors. In some cases, the lack of correspondence means that the flow presents characteristics of different service, and may be classified accordingly.

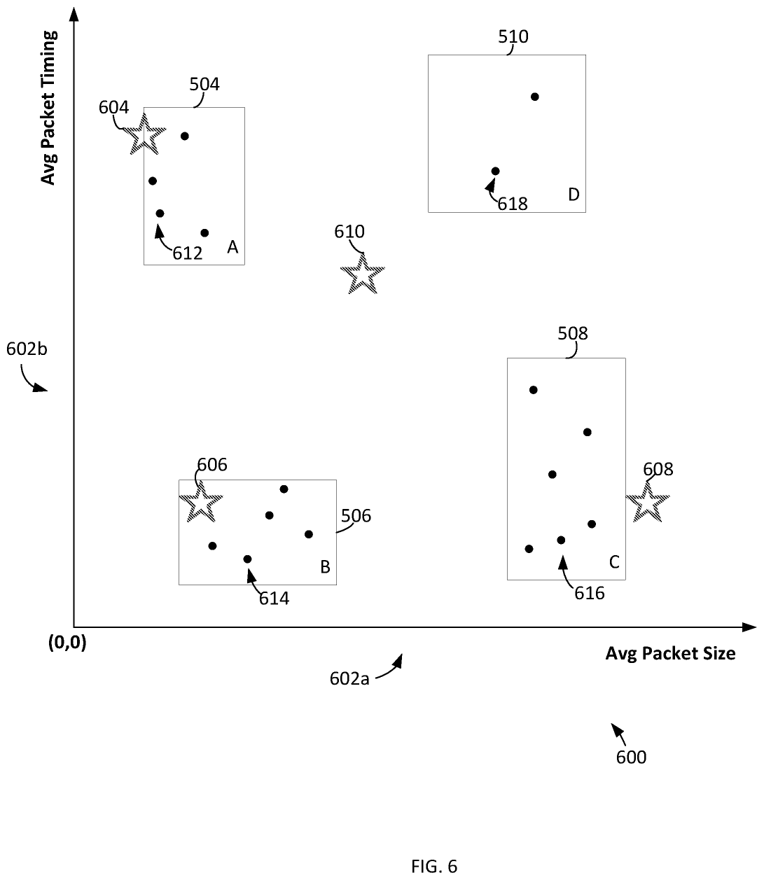

FIG. 6 illustrates a graph 600 showing tagging of clusters (also called classification of clusters) according to an example. The graph 600 includes a first axis 602a showing the average packet size of packets collected using the sensors, and a second axis 602b showing the average timing of the packets. The graph 600 further includes a first known signature 604, a second signature 606, a third signature 608, and a fourth signature 610. The graph 600 also includes tensor A 504, tensor B 506, tensor C 508, and tensor D 510. Each elementary tensor 504, 506, 508, 510 also includes a respective plurality of flows. Tensor A 504 includes a first plurality of flows 612, tensor B 506 includes a second plurality of flows 614, tensor C includes a third plurality of flows 616, and tensor D includes a fourth plurality of flows 617. Each plurality of flows 612, 614, 616, 618 is represented by one or more dots on the graph 600, where each dot represents at least one flow.

The various elementary tensors 504, 506, 508, 510 and associated flows 612, 614, 616, 618 are further classified as being originated from a particular service. In some examples, the constituent flows of the tensors 504, 506, 508, 510 are associated with the signature 604, 606, 608, 610 most similar (e.g., best fitted) to the flows and/or tensors 504, 506, 508, 510. In some examples, the classification is carried out by using a distance (Euclidean or non-Euclidean) of the flows 612, 614, 616, 618 to the signatures 604, 606, 608, 610. For example, the second plurality of flows 614 associated with tensor B 506 are most similar to the second signature 606. To reach the conclusion that the second plurality of flows 614 are most similar to the second signature 606, a controller, such as a processor or computer, may calculate the average distance of the constituent flows of tensor B 506 to each signature 604, 606, 608, 610. The signature 604, 606, 608, 610 having the smallest average distance may then be associated with the flows of tensor B 506. That is, tensor B 506 and the flows it contains are considered to be part of the service corresponding to the second known signature 606.

More generally, a similar process may be performed for each elementary tensor 504, 506, 508, 510, where the respective plurality of flows 612, 614, 616, 618 of the respective tensors 504, 506, 508, 510 are associated with the service corresponding to the best fitting signature 604, 606, 608, 610 to those flows. In FIG. 6, the flows of tensor A 504 are best fitted to the first signature 604, according to various metrics. Therefore, the flows 612 of tensor A 504 may be associated with the service corresponding to the signature of the second signature 604. Likewise, the flows of tensor D are best fitted to the fourth signature 610, and thus the flows of tensor D 510 would be associated with the flow corresponding to the fourth signature 610.

As previously mentioned, in some examples a simple average distance (here computed according to the packet size and timing of the axes 602a, 602b) of the flows of a cluster (or elementary tensor 504, 506, 508, 510) to the signatures 604, 606, 608, 610 is used to determine which signature is most similar and thus which signature to associate with a given cluster. However, the distance measurement is not limited to Euclidean distance or simple averages. Other metrics may be used, such as statistical algorithms or machine learning models, that determine other potential metrics for similarity, said metrics being either Euclidean or non-Euclidean.

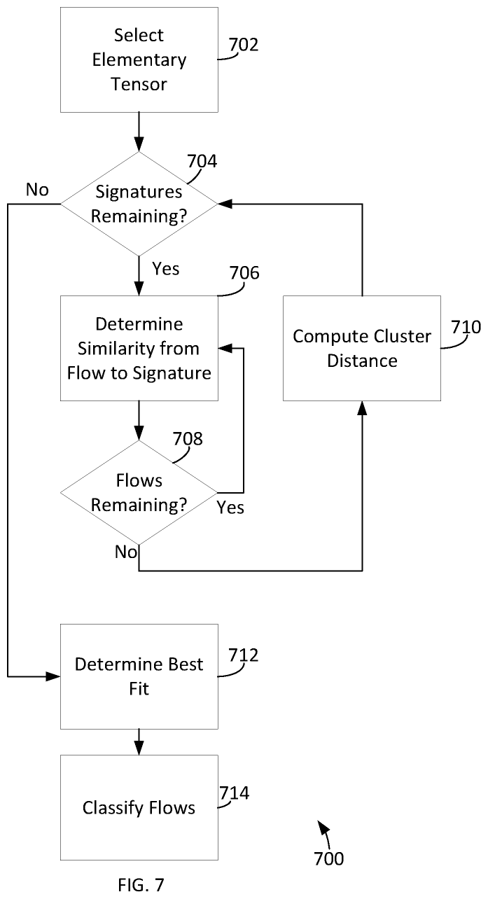

FIG. 7 illustrates a process 700 for tagging or classifying flows and/or an elementary tensor (that is, a cluster of flows) according to an example.

At Act 702, the controller selects an elementary tensor and identifies the flows associated with that elementary tensor. The flows associated with the elementary tensor may be treated as a cluster (that is, a collection or set) of flows. The process 700 may then continue to act 704.

At act 704, the controller determines whether any signatures remain to compare to the cluster. If signatures remain to compare to the cluster (704 YES), the process 700 continues to act 706. If no signatures remain to compare to the cluster (704 NO), the process 700 continues to act 712.

At act 706, the controller determines the similarity of a flow of the cluster to the signature, called the flow similarity herein. The controller may compute the flow similarity between the flow and the signature using a Euclidean distance (for example, using the general equation for distance between two points in n-dimensions, where n is an integer) and/or may using a non-Euclidean distance. Once the controller has determined the flow similarity, the process 700 may continue to act 708.

At act 708, the controller determines if there are any additional flows for which the flow similarity has not been calculated. If the controller determines that there is at least one flow for which the flow similarity has not been calculated (708 YES), the process may return to act 706 and repeat acts 706 and 708 until, for example, the flow similarity for each packet in the cluster has been calculated. If the controller determines that no further flow remains for which the flow similarity has not been calculated (708 NO), the process 700 may continue to act 710.

At act 710, the controller determines the similarity of the cluster to the signature, called the cluster similarity. In some examples, the cluster similarity is based on the flow similarities of each flow in the cluster. For example, the cluster similarity may be an average, or minimum of the flow similarities or may be composite of the flow similarities. In some examples, the cluster similarity may be determined using a machine learning algorithm or a statistical algorithm. The process 700 may then continue to act 704.

If the cluster has been compared to each signature (704 NO), the process 700 continues to act 712. At act 712, the controller determines the cluster similarity of the cluster with respect to each signature, and determines the best fitting signature. The process 700 then continues to act 714.

At act 714, the controller associates the flows of the cluster with the service (or services) associated with the signature. Each flow of the cluster may be classified by the controller as belonging to the service associated with the signature. The controller may treat the flows as belonging to the service, and other devices on the network (e.g., network switches and other nodes) may be controlled to treat the packets associated with the classified flow according to a user's desires.

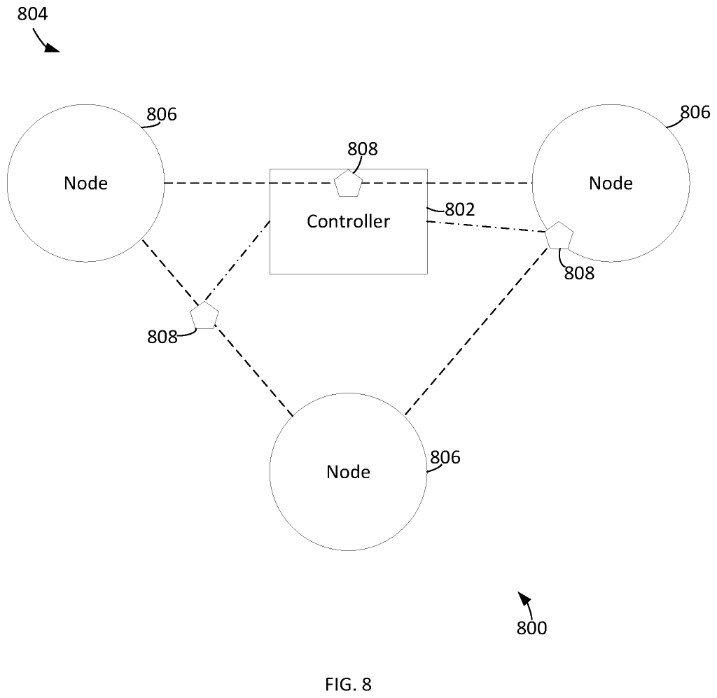

FIG. 8 illustrates a system 800 having a network 804 and a controller 802 according to an example. The network includes a plurality of nodes 806. The nodes 806 may be any type of network device (e.g., computers, routers, network switches, servers, and so forth). The nodes 806 are coupled to one another such that the nodes 806 can communicate with each other, for example by transmitting packets and/or flows to one another.

The controller 802 may monitor the flows between the nodes 806 using sensors 808. The sensors 808 may be located between two nodes or in and/or at a node. The sensors 808 may be integrated into the controller 802, and the controller 802 may be located anywhere (e.g., between two nodes, at a node, or elsewhere).

In some cases, the controller 802 may sense packets or other data associated with a flow by intercepting traffic directly using a sensor 808 integrated into the controller 802. In other examples, the controller can receive packets or other data (e.g., flow and packet attributes) directly from the nodes 806. In some example, the controller 802 may receive data from sensors 808 located independently located.

Multiplexed or Tunneled Flow Detection

Aspects and elements of this disclosure also relate to classifying multiplexed or tunneled flows. Multiplexed flows may include flows that are encrypted, such as by a virtual privacy network (VPN) or other encrypted tunnel. While flow classification may be performed using the systems and methods described above, when a flow is multiplexed and/or encrypted, certain characteristics of the flow can be obfuscated or changed, making it more difficult to determine what service originated the flow. Systems and methods disclosed herein include ways to identify multiplexed flows and to classify the multiplexed flow.

In some examples, a machine learning model is trained on set of data of non-multiplexed or non-tunneled flows. In some examples, the training data includes only non-multiplexed flow data. The same technique exists where the training data includes only multiplexed or tunneled flows. The machine learning model can take an n-dimensional input (the dimensions being attributes of packets of the signals— e.g., size, length, statistical values, and so forth) and compress the input down to m-dimensions, where in is less than n. The model then attempts, to extrapolate an n-dimensional output from the m-dimensional compressed version. The resulting n-dimensional output is compared to the n-dimensional input to evaluate the error between the two and to see if they are similar. The training process repeats this step multiple times which results in determining a decision threshold. If a flow's n-dimensional inputs meet the requirements of the decision threshold (e.g., the error is sufficiently low and/or the similarity of the two versions is sufficiently high), the related flow is considered to not have been multiplexed. On the other hand, if the error is too large compared to the decision threshold (e.g., the two versions are not very similar or not within a threshold level of similarity), the original input is considered to have been multiplexed.

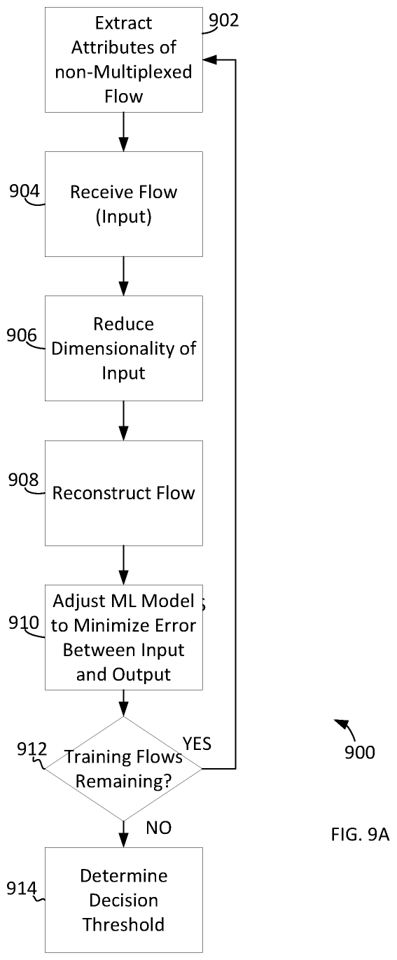

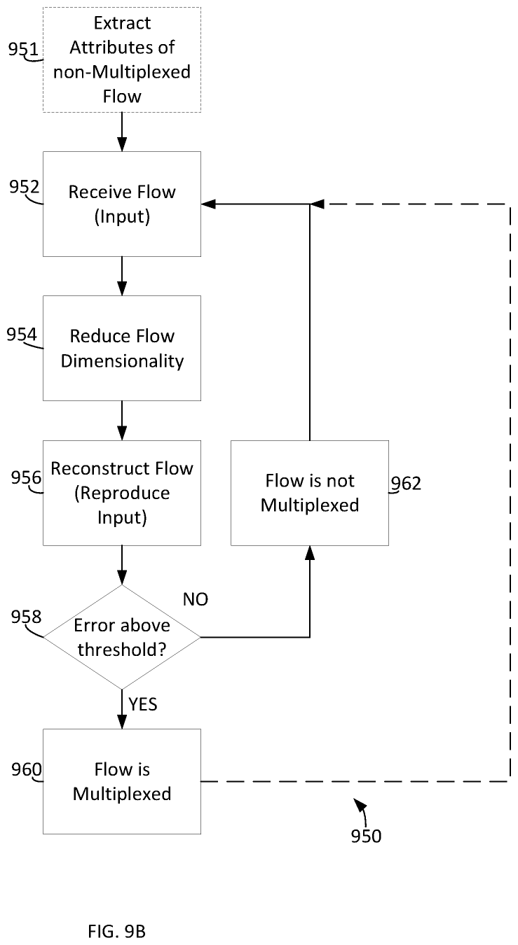

FIG. 9A illustrates a process 900 for training a machine learning model to detect a multiplexed or tunneled flow according to an example.

At act 902, a controller extracts the attributes of a non-multiplexed flow, flows, or connection. The controller may use a statistical algorithm or machine learning model to extract the characteristics of the non-multiplexed flow. In this process 900, extracting the attributes includes observing attributes that are present (such as packet size, interpacket intervals, packet duration and timing, and so forth) as well as derivable attributes (such as means, medians, variances, moments, and so forth). The process 900 then continues to act 904.

At act 904 the controller receives an input flow. The input flow may be identified, and in the case of training, may be known to be associated with a service. The process 900 then continues to act 906.

At act 906, the controller compresses the flow attributes using a dimensionality reduction algorithm or system. The dimensionality reduction algorithm may be based on an AutoEncoder neural network structure or a similar algorithm or machine learning model. In general, the controller takes an n-dimensional input and reduces it to less than n dimensions via compression. The weights of the dimensionality reduction algorithm may be set using machine learning processes or determined by the user, and the dimensionality reduction algorithm may be multi-stage— that is, the dimensionality reduction algorithm may have multiple layers wherein nodes of various layers have different weights. Once the controller has finished compressing the n-dimensional input down to less than n-dimensions, the process 900 may continue to act 908.

At act 908, the controller takes the compression layer (that is, the less than n-dimensional reduction of the flow attributes) and attempts to reconstruct the original flow based on the internal weights of the machine learning system that resulted from training so far. The process 900 may then continue to act 910.

At act 910, the controller adjusts the machine learning model to minimize the error between the n-dimensional input and the n-dimensional output. The machine learning model may, for example, know or assume that the flow or flows were not multiplexed. The machine learning model may then adjust the weights and other aspects of the algorithm used to produce the n-dimensional output from the less-than n-dimensional compression layer to reduce the error (that is, to get a better reconstruction of the original input).

At act 910, the controller determines if the error between the input and output has been minimized. Determining that the error has been minimized may include determining that the error is below a threshold error level (for example, 5%, 10%, and so forth). Adjusting the machine learning model may include adjusting the model (either through refinement or through the use of additional training flows, as described with respect to act 912) until the error is below the threshold error level.

The process 900 may then continue to act 912.

At act 912, the controller determines if there are any remaining training flows. If the controller determines there are remaining training flows (912 YES), the process 900 may return to act 902 and repeat the intervening acts of the process 900 until all the training flows have been processed by the controller to adjust the machine learning model as described with respect to act 910. If the controller determines that there are no remaining training flows (912 NO), the process 900 may continue to act 914.

At act 914, the controller determines a decision function or decision threshold. The decision function and/or threshold may be based on the training of the machine learning model as described below, and may represent a threshold similarity (or, alternatively, a minimum error) to classify a flow as multiplexed and/or tunneled.

FIG. 9B illustrates a process 950 for determining if a flow is multiplexed or tunneled according to an example. In FIG. 9B, the controller uses the decision threshold (or function) that resulted from the training process described with respect to FIG. 9A to determine if a flow is multiplexed or tunneled.

At optional act 951, controller extracts the attributes of a non-multiplexed flow, flows, or connection. The controller may use a statistical algorithm or machine learning model to extract the characteristics of the non-multiplexed flow. In this process 950, extracting the attributes includes observing attributes that are present (such as packet size, interpacket intervals, packet duration and timing, and so forth) as well as derivable attributes (such as means, medians, variances, moments, and so forth).

At act 952, the controller identifies a flow as an input. The process 950 may then continue to act 954.

At act 954, the controller compresses the flow using the dimensionality reduction algorithm determined during process 900 of FIG. 9A. As with act 906 of FIG. 9A, the controller takes the n-dimensional input (the flow) and compresses it down to less than n dimensions to produce the output. The weights of the dimensionality reduction algorithm may be set using machine learning processes or set by the user, and the algorithm may be multistage— that is, the dimensionality reduction algorithm may have multiple layers wherein nodes of various layers have different weights. Once the controller has finished compressing the n-dimensional input down to less than n-dimensions, the process 950 may continue to act 956.

At act 956, the controller takes the compression layer (that is, the less than n-dimensional reduction of the flow attributes) and attempts to reconstruct the original flow based on the internal weights of the machine learning system that resulted from training. In principle, if the flow is not multiplexed, the controller should be able to reconstruct a flow that is close-to the original flow (that is, the original input) using the learned signatures of the non-multiplexed traffic. However, if the input flow was multiplexed, then reconstructing the input flow using the signature of the non-multiplexed traffic will result in a relatively large amount of incorrect reconstruction (e.g., errors). The process 950 may then continue to act 958.

At act 958, the controller compares the input flow to the reconstructed flow. If the controller determines that the flow is below a threshold error (958 NO), the process 950 continues to act 962. If the controller determines that the flow is above the threshold error (958 NO), then the process 900 continues to act 960.

At act 960, the controller determines and/or classifies the flow as a multiplexed flow. Optionally, the process 950 may then return to act 952 and iterate for additional flows.

At act 962, the controller determines and/or classifies the flow as a not-multiplexed flow. The process 950 may then return to act 952 and iterate for additional flows.

In some examples, the process 950 may be considered a form of anomaly detection. For example, each flow existing between two nodes could be processed using the process 950. Those flows that have low error between input and output may be discarded, while those that do not may be classified as anomalous flows and/or may be considered multiplexed.

The processes 900 and/or 950 is not the only method of determining whether a flow is multiplexed and/or tunneled. In some examples, the processes 900 and/or 950 may be modified or replaced such that, instead of training the model on non-multiplexed flows, the model is trained on multiplexed or tunneled flows and used to identify multiplexed or tunneled flows directly. However, this method may have limitations. For instance, each multiplexed flow may have unique characteristics corresponding to how exactly the multiplexing is occurring.

Furthermore, while tunneled flows and multiplexed flows have different meanings to those of ordinary skill in the art, the terms may be used in lieu of one another with respect to any process or system described herein. For example, where process 900 refers to multiplexed flows, in general it could refer to tunneled flows instead and be equally valid, and where process 900 refers to tunneled flows, it could refer to multiplexed flows and be equally valid as well.

Multiplexed Flow Classification

Multiplexed flows, such as flows within a virtual privacy network, may appear as a single multiplexed flow. For example, an encrypted tunnel may carry more than one flow, but because each flow is “wrapped” within the encrypted tunnel, the flows may appear as one flow to an outside observer who cannot defeat the encryption. Aspects of this disclosure relate to demultiplexing multiplexed flows. For example, the techniques described herein allow an encrypted tunnel carrying multiple flows to be classified into multiple flows without breaking the encryption on the flows.

The principle of the technique is to take a historical sample of packets from a flow and then predict attributes or states of the next packet. If the next packet's attributes or state are sufficiently close to the predicted attributes or state, the next packet may be classified as belonging to a particular flow, as may be any packets used to make the prediction and future packets matching the prediction and/or future prediction. Packets classified as belonging to a particular flow may be ignored for the next prediction, thus allowing the system to categorize a second set of packets as belonging to a particular flow, and so forth. In a sense, this process is akin to peeling an onion in that a first “layer” (that is, set) of packets can be classified and “removed” (that is, ignored), and then a second layer of packets can be treated the same way, until all of the desired flows, up to all the flows, are classified. Because this technique relies on predicting attributes of packets, there is no need to break the encryption on the multiplexed flows if encryption is present.

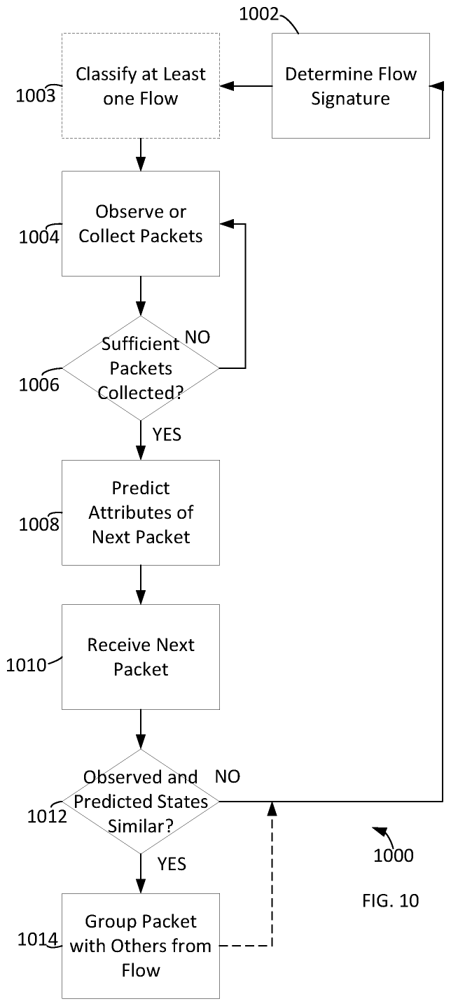

FIG. 10 illustrates a process 1000 for demultiplexing a multiplexed or tunneled flow according to an example.

At optional act 1002 the controller determines a signature for the service to compare to potential flows contained within a multiplexed flow. The signatures may be determined ahead of time or contemporaneously. The signatures may be determined using machine learning or other statistical techniques (for example, those described herein with respect to earlier figures). The process 1000 may then continue to act 1003.

At optional act 1003, the controller may classify at least one flow within the multiplexed flow. In some examples, the controller will classify the at least one flow because the at least one flow dominates all other activity within the multiplexed flow or because the at least one flow is the only activity in the multiplexed flow. In some examples, once the controller classifies the at least one flow in this way, the controller may use a model corresponding to the classification of the at least one flow for each following act of the process 1000. The process may then continue to act 1004.

At act 1004, the controller observes or collects historical packet data. Historical packet data may be a set of the most recent packets, for example, the most recent 20, 200, 1000, 10000 packets, or may be a set of historical packets that were collected or observed prior to the next prediction. In some examples, the number of packets collected will be a statistically significant number of packets so that the prediction algorithm can create a good prediction of the next packet's or packets' attributes. In such an example, the minimum number of packets is determined by the algorithm. The process then continues to act 1006.

At act 1006, the controller determines if a sufficient number of packets have been collected to make a good prediction. If the controller determines that a sufficient number of packets have been collected (1006 YES), the process 1000 continues to act 1008. If the controller determines that an insufficient number of packets were collected (1006 NO), for example, too few packets to make a meaningful prediction of the next packet or packets, the process 1000 may return to act 1004 to collect additional packets, or the process 1000 may return to act 1002.

At act 1008, the controller predicts at least one attribute and/or state of the one or more packets that have not yet been received. The one or more packets may be the next packets to be received belonging to the multiplexed flow. The at least one attribute may include packet size, packet duration, interpacket timing, as well as any derivative attributes. The controller may predict the state of the next packet using a machine learning model or other statistical algorithm. In some examples, the controller uses the signature (from act 1002) to determine the predicted packet state at least in part, since the signature may be used to guess the state of a packet belonging to a flow having the given signature. The process 1000 may then continue to act 1010.

At act 1010, the controller receives one or more next packets. The one or more next packets may be packets belonging to the multiplexed flow. The one or more next packets may be packets received after the controller makes the prediction of the at least one attribute and/or state of the one or more packets that have not yet been received. Once the packet and/or packets are received, the process continues to act 1012.

At act 1012, the controller determines whether the received attribute and/or state or states of the next packet and/or next packets are similar to the predicted attribute and/or state or states. For example, the controller may compare a predicted packet length to the actual packet length of the received packet, and so forth. If the received packet or packets are within a threshold similarity to the prediction (e.g., 50%, 70%, 80%, 90%, 95% similar, and so forth) (1012 YES), the process continues to act 1014. The controller may determine a similarity metric using a machine learning algorithm or other statistical algorithm. In some examples, the controller may also use a Euclidean distance metric to determine the relative similarity of two or more packet states. For example, a packet length may be 8 bytes, and the predicted length may be 10 bytes. The actual packet was thus 80% (or 0.80 times) the size of the predicted packet, and thus the packets are 80% similar. If the packets are not above the minimum threshold similarity (1012 NO), the process 100 may return to an earlier act, such as act 1002. In such a circumstance, the controller may return to act 1002 to select a new signature and repeat the acts of the process 1000 as necessary until a signature is found that results in a prediction that exceeds the minimum threshold similarity.

At act 1014, the controller may consider the prediction successful and may classify the observed packets and the historic packets as belonging to a particular constituent flow of the multiplexed flow.

The process 1000 may then optionally return to act 1002 to select a new signature, so that the controller can begin “peeling the onion,” that is, identifying additional constituent flows within the multiplexed flow. In those future iterations of the process 1000, the controller may ignore packets classified as belonging to an identified constituent flow, such that future predictions are based only on packets of the multiplexed flow belonging to unidentified and/or unclassified constituent flows.

In a special case, the multiplexed flow may be known or may be likely to have only a single constituent flow. In such a case, while the techniques discussed with respect to FIG. 10 will still work to classify the constituent flow, the tensor decomposition and cluster tagging methods described herein may also be used in lieu of the techniques described with respect to FIG. 10.

Associating Related Flows

As mentioned herein, some flows are collections of related flows, or reencoded versions of themselves. For example, a VoIP communication is often not just a single flow, but may include multiple helper flows that assist one or more core flows to facilitate communication and transmission of data between two or more network nodes. However, associating a core flow with its helper flows, or associating a reencoded flow with a different version of itself, can be difficult. For example, network jitter, reencoding, and other network events may result in changes to the packets of flows from node to node. As a result, it is inefficient to attempt to associate core flows and helper flows simply using patterns directed to things like packet size, duration, or interpacket timing.

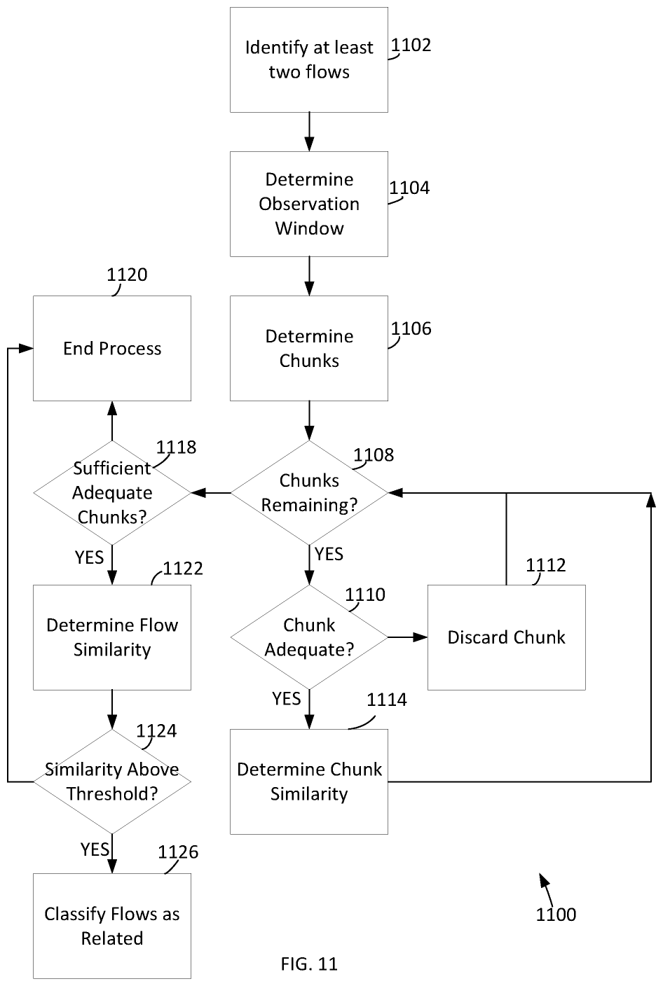

FIG. 11 illustrates a process 1100 for determining if two or more flows are related to one another according to an example.

At act 1102, the controller identifies or selects at least two flows that may be related. For the sake of simplicity, the two flows will be referred to as the first flow and the second flow, and will be used in an illustrative manner throughout the discussion of FIG. 11. The process 1100 then continues to act 1104.

At act 1104, the controller determines an observation window. The observation window may be any length of time, for example, 1 millisecond, 1 second, 20 seconds, 1 minute, many minutes, hours, days, and so forth. In general, the observation window may be relatively short for applications requiring data immediately or over short-time periods (such as actuators to manipulate flows in real-time), and may be longer for applications not requiring data immediately (e.g., forensic applications). The process 1100 then continues to act 1106.

At act 1106, the controller determines the chunks of the observation window. The chunks are portions of the observation window— that is, the observation window is divvied into chunks. The chunks may be of uniform length or of a variable length. For example, if the observation window is 20 seconds, each chunk could be 1 second, or there could be two 5 second chunks and one 10 second chunk, and so forth. The process 1100 then continues to act 1108.

At act 1108, the controller determines if there are any chunks remaining that have not been examined for adequacy and similarity. If the controller determines that some chunks remain unexamined (1108 YES), the process 1100 continues to act 1110. If the controller determines that no unexamined chunks remain (1108 NO), the process continues to act 1118.

At act 1110, the controller determines if the chunk is adequate. The controller may determine a chunk to be adequate if the chunk contains a sufficient number of packets related to the first and/or second flow to make a comparison between those two flows. A chunk may be determined to be inadequate if it lacks sufficient packets related to the first and/or second flow to make a comparison. In some examples, a sufficient number of packets is a number of packets that would provide a statistically significant comparison, or would provide the right distribution of packets. If the controller determines the chunk is adequate (1110 YES), the process 1100 continues to act 1114. If the controller determines the chunk is not adequate (1110 NO), the process 1100 continues to act 1112.

At act 1112, the controller discards the inadequate chunk. Discarding the chunk may mean that the controller ignores the inadequate chunk in any future calculations or determinations. Discarding the chunk may also mean freeing memory or other resources that were used with respect to the chunk. The process 1100 then returns to act 1108, where the controller may check if any other chunks remain and repeat acts 1110, 1112, 1114, and/or 1116 as needed until all chunks have been examined.

At act 1114, the controller determines the similarity of two or more flows within a given chunk. In some examples, the controller makes a determination of temporal similarity between packets of the flows. In some examples, the determination of temporal similarity is made using the metric described in the work of Hunter and Milton in their work “Amplitude and Frequency Dependence of Spike Timing: Implications for Dynamic Regulation,” Journal of Neurophysiology, vol. 90, no. 1, pp. 387-394 (July 2003), which is incorporated herein by reference for all purposes and particularly with respect to the definition and calculation of the temporal similarity metric described therein (the “Hunter-Milton metric” hereafter), which should provide a value close to or equal to 1 if the events are very close in time, and close to or equal to 0 otherwise. The similarity metric (e.g., Hunter-Milton) may be modified to account for the shape of the flow as well. For example, if one flow triggers another flow, a weight may be applied to reflect this cause-effect relationship.

When determining the chunk similarity, in some examples the controller may compare the temporal similarity of each packet in one flow to the nearest packet (in time) of the other flow to derive a value reflecting temporal similarity. Furthermore, the chunk similarity metric may be asymmetric. That is, the similarity of the first flow to the second flow may be different than the similarity of the second flow to the first flow. Once the similarity of flows for a given chunk (chunk similarity) is determined, the process 1100 continues to act 1116.

At act 1118, the controller determines if there was a sufficient number of adequate chunks. For example, if the observation window was divided into 20 chunks, it may be desirable to have at least a minimum number of chunks that were adequate (for example, 50%, 70%, 80%, 100% of the chunks, or a minimum number of adequate chunks, or a minimum proportion of adequate chunks to total chunks, and so forth). If the controller determines that the number of adequate chunks is below the minimum number of adequate chunks (1118 NO) the process 1100 may continue to act 1120. If the controller determines that a sufficient number of the chunks were adequate (1118 YES), the process 1100 may continue to act 1122.

At act 1120, the controller may terminate the process 1100 or can restart with respect to a new pair of flows (e.g., a pair of flows containing at least one flow not previously considered).

At act 1122, the controller determines the flow relatedness. The flow relatedness is an overall comparison of the similarity of the two flows, typically in temporal terms. The flow relatedness may be determined by taking each adequate chunk and comparing the composite chunk similarity to a threshold value (under the Hunter-Milton metric, the threshold value could be any value between 0 and 1, for example 0.65, 0.75. 1, and so forth). If the composite chunk similarity is above the threshold value, the chunk may be considered a positive match, indicating similarity between the flows. Once the controller has compared the chunk similarity of each chunk to the threshold value, the controller may determine the flow relatedness value based on the chunk similarity values of the number of chunks that exceeded the threshold value compared to the number of chunks considered. For example, the flow relatedness may be equal to the number of chunks having a chunk similarity above the threshold value divided by the total number of chunks and/or the total number of adequate chunks. The process 1100 may then continue to act 1124.

At act 1124, the controller determines whether the flow relatedness is above a threshold value. If the flow relatedness is above the threshold value (1124 YES), the process 1100 continues to act 1126. If the flow relatedness is below the threshold value (1124 NO), the process 1100 may continue to act 1120. In some examples, the threshold may be 0.80 or any other value. The value of the threshold may be determined numerically or using a machine learning algorithm or other statistical algorithm.

At act 1126, the controller classifies the first and second flow as related flows using the decision of act 1124 and other rules based on e.g., IP addresses, ports, etc. For example, one may be a core flow and the other may be a helper flow, or both may be related helper and/or core flows, or both may be the same flow but one is reencoded relative to the other.

The results of process 1100 may be further refined using a graph clustering method. The related flows may be transformed into a graph where nodes are the flows and edges are based in part on flow relatedness as computed via process 1100. Graph clustering methods may be employed to group related and lightly related flows and separate the flows that are unrelated such that all flows from the same service, even though whose relatedness is faint or difficult to determine may be grouped together. Clustering methods like k-clustering, spectral graph clustering, etc. are all applicable.

In the above example, it is possible to use one sensor to identify flows, however, where a reencoding step is present (for example, when the flow is reencoded by the second node 304 of FIG. 3), it is desirable to have a sensor present on each side of the node that performs the reencoding. The sensors need not be directly adjacent to the node that performs the reencoding, they may be multiple nodes away from the node that performs the reencoding. Furthermore, in some circumstances, only a single sensor may be needed (e.g., a network with a circular topology).

For a case where the first and second flows are serving the same service (for example, both are related to the same activity), a method for relating the two flows may also include plotting the cumulative size over time for a given time interval (e.g., 5 seconds, 20 seconds, and so forth) and computing a linear regression over each flow for each time interval. Then, for each flow, note the slope and intercept of the linear regression and plot each point in a 2D space. Based on the foregoing information, cluster pairs of flows using a clustering algorithm (such as a nearest neighbor algorithm, or any other clustering algorithm). This method may be applied to more than two flows, as the aspects and elements of this method are not limited to two flows. Thus, it is possible to compute cumulative size for any number of flows, compute the linear regression over each flow for each time interval, and use the clustering algorithm.

In the foregoing, statistical significance (e.g., of a comparison or a statistically significant number of packets to make a prediction, and so forth), may mean sufficient numbers of the thing (e.g., packets) to be analyzed such that a “P” value of the resulting analysis is below a threshold value (e.g., 0.05 or any other value desired by the user). Likewise, the number of packets required may, in some examples, be a number that provides a desired distribution of packets, or enough packets to meet the needs of the algorithm, and so forth.

Although aspects of this disclosure focus on flows, the methods described herein may be modified to act on network connections as well. In such instances, certain attributes could be readily modified to account for the changes (for example, interpacket time could go from being time between packets in a flow to time between any packets in the network connection regardless of the associated flow).

Various controllers, such as the controller 802, may execute various operations discussed above. Using data stored in associated memory and/or storage, the controller 802 also executes one or more instructions stored on one or more non-transitory computer-readable media, which the controller 802 may include and/or be coupled to, that may result in manipulated data. In some examples, the controller 802 may include one or more processors or other types of controllers. In one example, the controller 802 is or includes at least one processor. In another example, the controller 802 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method for determining whether two flows are related comprising:
identify a first flow;
identify a second flow;
collect one or more attributes of one or more packets of the first flow and second flow during an interval of time;
determine a flow similarity of the first flow and the second flow based on the one or more attributes;
determine that the flow similarity exceeds a similarity threshold; and
responsive to determining that the flow similarity exceeds a similarity threshold, determine that the first flow and second flow are related flows.

2. The method of claim 1 wherein determining the flow similarity of the first flow and the second flow includes:
determining a first similarity of the first flow to the second flow;
determining a second similarity of the second flow to the first flow; and
determining a composite similarity based on the first similarity and the second similarity, wherein the flow similarity is based on the composite similarity.

3. The method of claim 1 wherein collecting one or more attributes of one or more packets of the first flow and second flow during an interval of time includes:
dividing the interval of time into a plurality of subintervals of time; and
determining that each subinterval of the plurality of subintervals has a statistically significant quantity of the one or more packets associated with it.

4. The method of claim 3 wherein determining a similarity of the first flow to the second flow further comprises determining a similarity of the one or more packets of the first flow and the second flow with respect to each subinterval of time of the plurality of subintervals of time.

5. The method of claim 4 wherein determining a similarity of the one or more packets of the first flow and the second flow with respect to each subinterval of time includes:
determining a first similarity of packets of the first flow with respect to packets of the second flow;
determining a second similarity of packets of the second flow with respect to packets of the first flow; and
determining a composite similarity of the subinterval based on the first similarity and the second similarity.

6. The method of claim 5 wherein the composite similarity is an average of the first similarity and the second similarity.

7. The method of claim 5 further comprising determining the flow similarity based on each composite similarity of each subinterval.

8. The method of claim 7 wherein the flow similarity is determined based on a proportion of subintervals having a composite similarity above a threshold similarity.

9. The method of claim 8 wherein the number of the subintervals is greater than a number of the subintervals having a composite similarity above the threshold similarity.

11. The method of claim 7 wherein determining that the flow similarity includes determining that the proportion of subintervals having a composite similarity above a threshold composite similarity is greater than the threshold proportion.

12. A system for determining whether two flows are related comprising:
at least one sensor configured to monitor a first flow and a second flow; and
a controller configured to:
determine one or more attributes of one or more packets of the first flow and the second flow during an interval of time;
determine a flow similarity of the first flow and the second flow based on the one or more attributes; and
responsive to determining that the flow similarity exceeds a threshold flow similarity, categorize the first flow and second flow as related flows.

13. The system of claim 12 wherein the controller is further configured to:
divide the time interval into a plurality of subintervals of time;

14. The system of claim 13 wherein the controller is further configured to determine whether a subinterval contains a statistically significant quantity of packets associated with the first flow and the second flow; and
discard subintervals of the plurality of subintervals that do not have a statistically significant quantity of packets associated with the first flow and the second flow.

15. The system of claim 13 wherein the controller is further configured to:
determine a first similarity of packets associated with the first flow to packets associated with the second flow for a respective subinterval;
determine a second similarity of packets associated with the second flow to packets associated with the first flow for the respective subinterval; and
determine a composite similarity based on the first similarity and the second similarity.

16. The system of claim 15 wherein the composite similarity is an average of the first similarity and the second similarity.

17. The system of claim 15 wherein determining the flow similarity is based upon each respective composite similarity of each subinterval.

18. The system of claim 17 wherein the flow similarity is a proportion of subintervals having a composite similarity above a threshold similarity to a number of subintervals.

19. The system of claim 18 wherein the number of subintervals is all subintervals except those discarded.

20. A method for determining whether two flows are related and carry the same service comprising:
collecting one or more attributes of one or more packets of the one or more flows during an interval of time;
modeling one or more flow characteristics based on the one or more attributes to produce one or more modeled flow characteristics;
comparing the flow characteristics to one or more modeled flow characteristics;
grouping the flows based on a similarity of the flow characteristics to the modeled flow characteristics; and
identifying related flows based on the grouping of flows.

21. The method of claim 20 further comprising extracting cumulative flow size versus time over periods of time responsive to collecting the one or more attributes, and wherein cumulative flow size versus time is used to model the one or more flow characteristics to produce the one or more modeled flow characteristics.

22. The method of claim 21 wherein modeling the one or more flow characteristics to produce the one or more modeled flow characteristics includes using linear regression.

23. The method of claim 21 wherein modeling the one or more flow characteristics to produce the one or more modeled flow characteristics includes using nonlinear regression.

24. The method of claim 20 wherein comparing the one or more flow characteristics to the one or more modeled flow characteristics includes comparing or plotting at least one flow characteristic on a multidimensional graph.

25. The method of claim 20 wherein grouping the flows includes using clustering algorithms.

26. The method of claim 25 wherein the clustering algorithm is the nearest neighbor clustering algorithm.

27. The method of claim 20 wherein identifying related flows based on the grouping of flows including validation of the grouping and reorganization of the grouping based on a set of rules.
